(19) United States
(12) Patent Application Publication
(10) Pub. No.: US 2004/0258311 A1
(43) Pub. Date: Dec. 23, 2004

(54) Method for generating geometric models for optical partial recognition

(75) Inventors: Kai Barbehoen, Munich (DE); Wilhelm Beutel, Riemerling (DE); Christian Hoffmann, Munich (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/822,165

(22) Filed: Apr. 12, 2004

Related U.S. Application Data
(63) Continuation of application No. PCT/DE02/03814, filed on Oct. 9, 2002.

(30) Foreign Application Priority Data
Oct. 11, 2001 (DE) 101 50 105.6

(51) Int. Cl. G06K 9/46

(52) U.S. Cl. 382/190

(57) ABSTRACT

Groups of form features can be, e.g., the properties of a picture object. By adding other form features exhibiting similarity with existing group form features, these groups of form features can be completed using a control with selectable threshold values and using additional information, in turn according to modified circumstances of the object. This enables a class of objects which are to be recognized to be represented in an approximative manner. The model thus produced can be used in a first step (A) for an optical partial recognition. In a second step (B), the features of the object recognized by the partial recognition can lead to enlargement and completion of the model. It is thereby no longer necessary for a specialist to have interactive control of the recognition system, and models exhibiting a high degree of representativity can be produced.

This is a Continuation of International Application PCT/DE02/03814, with an international filing date of Oct. 9, 2002, which was published under PCT Article 21(2) in German, and the disclosure of which is incorporated into this application by reference.

### FIELD OF AND BACKGROUND OF THE INVENTION

The invention relates to a method for generating a model that represents an image object class and thus serves as a recognition model for new members of that class.

In many areas of industry, optical and/or acoustic methods for inspecting work pieces are used in production, quality control or identity recognition. In addition to being able to recognize the products, the methods used must also be highly adaptable and stable because, as a rule, physical changes in the products to be inspected vary the characteristics of the object to be examined, e.g. due to poor quality, orientation or damage as well as different lighting conditions.

It is generally known to carry out object or pattern recognition using digital image and signal recording technologies and, in addition, image and signal processing routines for classifying the objects or patterns. The routines use methods for analyzing the image objects occurring in the digital images based on shape features, such as gray-scale contours, texture, as well as edges, corners and straight line segments. The particularly characteristic, reliable and descriptive shape features of an object are combined into a model. Different shape features lead to different models.

To record the object to be examined, it is placed under a camera. The resulting images are initially analyzed based on shape features occurring in the image of the object. Particularly characteristic shape features, such as straight line segments, corners, circles, lines or partial areas are recognized, extracted from the image and combined into a model. The selection of the shape features suitable for the model is based on a statistical analysis of all the extracted features from many images. At first, the measured values of the features scatter randomly around a mean value because of lighting differences, differences in the object and camera noise. The complications introduced as a result are currently compensated in an interactive process with a specialist. In essence, the models are generated and tested by a specialist.

The formation of groups, which are used in the invention, is a result of determining the similarities of the shape features generated from the images. Groups used to generate a model are developed based on similarities, e.g., feature type, length, angle, shape factor, area or brightness. Similar features are classified into groups. In this method, a group could, for example, represent the size of an area with a specific brightness or the shape of an edge with a specific intensity. Additional information from a new image, e.g., a similar brightness distribution or edge shape is subsequently added to the existing groups.

Since varying the characteristics of the object complicates, and as a rule even prohibits, the automatic generation of a representative model and the groups required therefor, the interactive use of an experienced specialist is necessary, as explained above. Since this use has no firm logical basis, however, the quality of the models cannot be guaranteed. These drawbacks result in significant costs for the use of the specialist and a lack of stable adaptivity of the recognition system, i.e., a lack of “quality” of the collected shape features, groups and the models resulting therefrom.

### OBJECTS OF THE INVENTION

Thus, one object of the invention is to provide a method for automatically generating models in which an automatic recognition of object descriptive features leads to the representative strength of the models with respect to the objects to be recognized. A further object is to enable the cost-effective adaptivity of a recognition system.

### SUMMARY OF THE INVENTION

These and other objects are attained, according to one formulation of the invention, by a method for automatically generating an object descriptive model, wherein: a selection of image signal information is recorded in an object descriptive group having object descriptive shape features, similarity criteria yield a decision whether an object descriptive feature is assigned to the group, a selectable threshold yields a decision whether the group becomes a part of the recognition model, at least strong groups are used for a model for a partial recognition of an object, strength being determined by the number of the group features, after a first model has been generated, additional images are recorded, wherein new object descriptive features are obtained by subjecting the new features to a similarity determination, and sufficiently similar new features are added to existing groups in completing the groups.

The invention is essentially characterized in that groups of shape features, which can be characteristics of an image object, are completed by adding other shape features, similar to the existing group shape features, comparing them with selectable threshold values and including additional information depending on the changed conditions of the objects, so that they approximately represent an object class to be recognized. The model thus produced can be used in a first step for an optical partial recognition. In a second step, the features of the object recognized in the partial recognition can lead to an expansion and completion of the model.

This has the advantage that it eliminates the need for interactive testing of the recognition system by a specialist and makes it possible to generate models with great representative strength.

In the method for automatically generating a model to describe an object, a selection of image signal information is collected in an object descriptive group with object descriptive shape features. Initially, similarities lead to the decision whether an object descriptive feature can be assigned to the group. A selectable threshold enables the decision whether the group becomes a component of the recognition-model. At least the strong groups are used for a model for partial recognition of an object. The strength is determined based on the number of group features. After a first model has been generated, additional images are recorded, so that new object descriptive features can be obtained. These features are subject to a similarity determination and may be added to existing groups, such that the groups can be further completed.

“Partial recognition” is defined specifically as the recognition of a part of an image object, which has the most important features of the object, or exhibits a specific feature clearly.

Optimally, the method is carried out such that additional object descriptive features are added to the existing groups based on a similarity determination until the groups no longer change significantly.

It is preferred to use statistical values to determine a degree of similarity between features previously included in the groups and new features.

These statistical values can be mean values and/or maximum values, and scattered measured values can be stored for each object descriptive feature. These measured values are used to characterize a model.

In an extremely important further refinement of the invention, a first partial recognition of an object shifted from the optical image recording axis is used to obtain transformation coefficients for the shifted object position. With an inverse transformation, the shape features of the shifted object are added to the corresponding existing groups if there is sufficient similarity, so that larger groups can be produced.

The transformation coefficients describe a change in size and/or a change in position of the object.

To make the recognition system more robust, images are recorded under more difficult conditions, changed image recording conditions, changed lighting, and/or a changed object position. First, object features are extracted from the images and, after a similarity determination, are added to existing groups, so that the groups become larger.

A further step for generating a robust geometric model is to establish imaging equations of one object position, taking into account the image recording technique and the perspective distortion to determine the relative position of an object feature.

In addition, or as an alternative thereto, an object descriptive model can be generated from a central position within the recording field. This model can be used for partial recognition of suitably shifted objects to generate a more extensive model for at least one additional object position. The appropriate shift is carried out in all directions, and the model is adjusted with each step.

A compensating calculation for all shifting steps can then be used to determine the relative three-dimensional position of an object and/or an object feature.

### BRIEF DESCRIPTION OF THE DRAWINGS

The invention is explained below, in greater detail, with reference to exemplary embodiments and drawings in which:

FIG. 1 shows a sequence of steps for generating a geometric model,

FIG. 2 shows a sequence for expanding a model, taking into account more difficult image recording conditions, and

FIG. 3 shows a sequence for expanding a model, taking into account perspective differences and characteristics of the recording electronics.

### DETAILED DESCRIPTION OF THE PREFERRED EMBODIMENTS

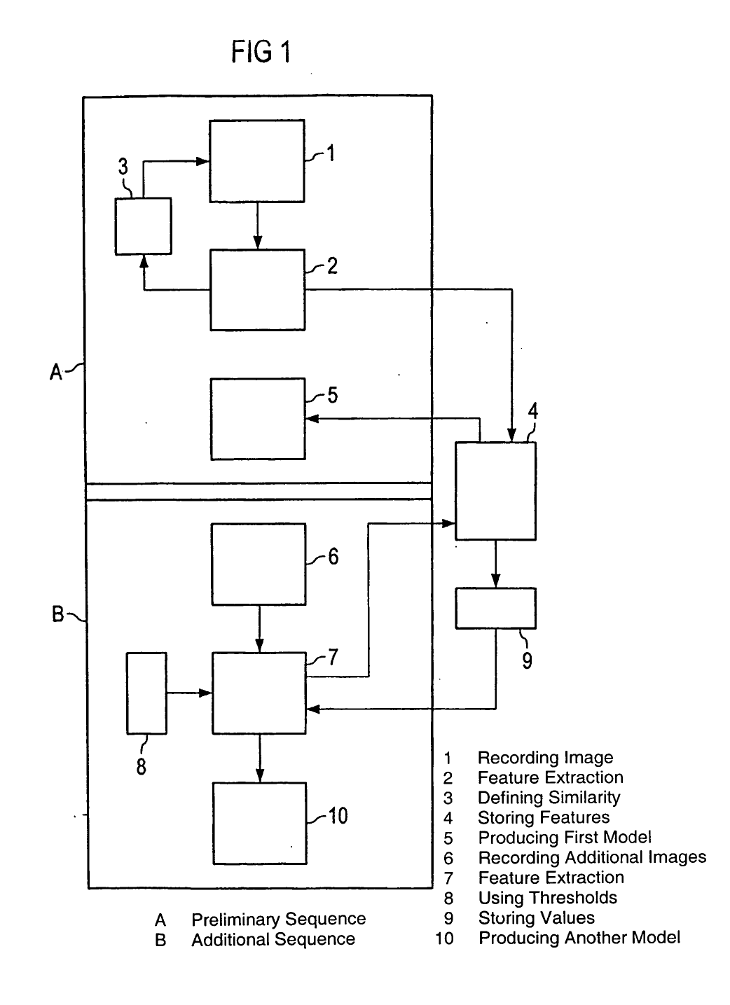

FIG. 1 shows the sequence for developing a geometric model by means of thresholds and similarity determinations. The preliminary sequence for generating a first geometric model is labeled A. Step 1 indicates the recording of the image of an object. It is followed by a feature extraction in step 2. To develop a group, the extent of a desired similarity is defined using thresholds for the similarity of each feature in step 3. Because the features from many images have to be extracted, the above-described steps are executed multiple times. The recorded shape features furthermore show scattering, which initially characterizes a group of similar features in the form of feature mean values or scattering. These mean values or degrees of scattering are used as a further basis for evaluating the similarity of a candidate to be newly included in the group, e.g., from a newly recorded image. These statistical values can be saved or stored no later than in step 9.

The subsequent sequence for storing a group of shape features is represented by step 4 in FIG. 1. This step is shown outside the two frames A and B because the groups are used in both sequence A and sequence B. The number of members assigned to a group is stored as the group's strength.

By suitably selecting the feature similarity thresholds, similar new features are added to the group, i.e., the group's number of members and thus the group's strength increase. For example, the distance of a new feature from the calculated mean of the previously accepted members of a group can be used as a similarity value. A lower and/or upper threshold for this distance would in this example be designated a threshold. Another threshold consisting of a minimum number of object descriptive features (each assigned to corresponding groups) can be used. Less similar features are excluded from the group. A larger group contains more information on the object, which is described more precisely by the group or by the scattering values.

For the description of a model, e.g., the representation of brightness distributions, the mean of the quantity of all the features included in the group is suitable. For other features occurring in the image, e.g., the length of a straight line or edge, a maximum of the quantity of all the features contained in the group would be apt to detect straight lines with a maximum length from future images as well.

Thus, according to the invention, depending on the characteristics of an image object, the mean values, maximum values or other suitable statistical values are used as characterizing features of a model.

A particular advantage of the above method is that the greater the number of group members, the more precisely an ideal mean can be calculated and the geometry of the object to be detected described. The strong groups represent the shape features that are particularly reliably extracted from the images and are therefore well suited for describing the object for a partial recognition.

After a series of images of an object have been recorded and the shape features extracted therefrom have filled the groups to a sufficient minimum size, i.e., the steps 1 to 4 of FIG. 1 have been executed multiple times, model features are derived therefrom and are combined into a first model for a partial recognition in step 5. The use of strong groups from step 4 is preferred because these groups represent the shape features that are most reliably and reproducibly extracted from the recorded images and, as a result, are optimally suited to describe the object or the model for at least a partial recognition. The model is used for a first partial recognition or a position determination for the object to be recognized. This model is not sufficient, however, to execute a partial recognition with great accuracy under more difficult conditions. The model can be used as a basis, however, for generating a more robust model, as described below.

To generate adaptive and reliable object descriptive models, differences between the recorded images must be taken into account, e.g., differences as a result of camera noise, lighting or the changed perspective of the camera.

The sequence of the method according to the invention for generating such a model is illustrated in the frame labeled B. The measured values, which are scattered due to the above-described effects, must be fully recorded. According to the invention, once the first model has been generated, additional images are recorded under changed conditions in step 6, and the descriptive shape features of these images are extracted therefrom in step 7. These shape features are again compared with the existing groups from step 4 and, if the similarity is sufficient, are included in the groups. Thresholds, which may have been changed under the new conditions, can be used in step 8. Overall, groups that may initially have been very small (and that did not contribute to the first model) continue to grow. In step 10, another model is then derived from the groups. This model represents a more complete and reliable description of the object. This modification process is repeated several times until the groups no longer change significantly.

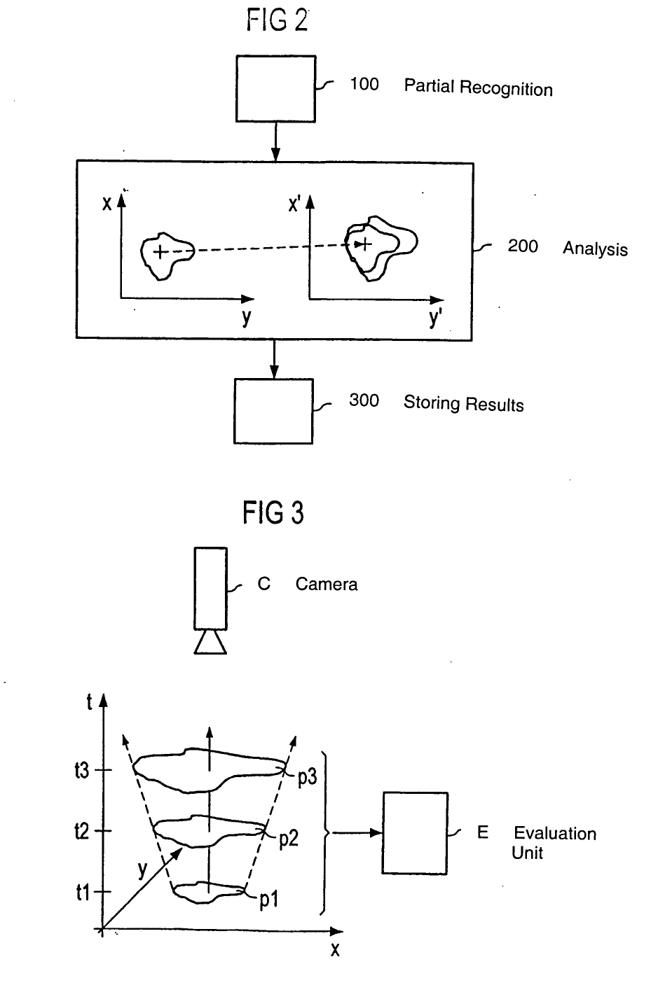

Although the above-described method already ensures a highly flexible recognition system, additional effects, e.g., a strong change in perspective, and the connected change in an object's profile, the length of straight lines, the radii of circles and areas must be taken into account. For example, the parameters of an object in a new position can no longer be readily compared with the parameters from the original model. To deal with this problem, a geometric transformation is used, by means of which the change in position or size of the object can be transformed into the order of magnitude of the position of an existing group. As a result, the shape features contained in the groups can continue to represent the characteristics of an object to be recognized. This sequence is illustrated in FIG. 2.

To obtain the geometric characteristics of this transformation, the change in position and size of the object is determined by means of an existing model using a partial recognition from step 100 of FIG. 2, since at least a partial recognition is possible even if the perspective of the shape features has changed. The differences between the new position thus determined and the position of the model (which contains the first, undistorted position of the object) define the coefficients required for an inverse transformation. These differences are executed with the analysis shown in step 200. The object recognized in the partial recognition is shown on the left and the distorted object on the right. The transformation is indicated by the dashed arrow and the changed coordinates x->x′ and y->y′. The results of the transformation can be initially stored in a step 300. With this inverse transformation, all the position-determining features from the images for a new object position are transformed back from this position into the model position. Likewise, all size-determining features from the images are transformed to the model size with a new object-to-image ratio, such that the transformed parameters are again similar to those of the original groups and the similarity can be compared. The partial recognition with position determination also serves to test the model for its suitability.

The scattering parameters of the groups show how strongly the feature parameters will scatter for the different image recording conditions in the partial recognition. To make the process of partial recognition as immune to such variations as possible, measured values, which characterize this scattering and ensure that slight deviations between the parameters of the model features and those of the new features generated from the recorded images are tolerated in the recognition, are stored in the recognition model for each feature. These scattered measured values are referred to as tolerances and are derived from the scattering parameters of the groups when the model is generated.

If the shape features of an object lie not only two-dimensionally in a single plane, i.e., orthogonally to the optical axis of the camera, but also have different distances in relation to the camera in the direction of the optical axis, then the recognition model must take these differences in distance into account so that the influence of the object position in the image on the mutual position of the shape features, i.e., the influence of the perspective distortion, can be taken into account.

To measure these differences in distance automatically when the model is generated, automatic recognition models can be produced for different object positions in the image. The mutual position of the shape features in the (2-D) image differs in these recognition models because of the perspective distortion. This sequence is shown in FIG. 3. By comparing these models of different object positions, p1, p2 and p3 and by assigning the corresponding shape features, the distance of the feature from the optical center in the direction of the optical axis can be calculated for each shape feature, together with additional information on the parameters of the camera and the lens. The perspective image of the camera C and the lens is modeled and a system of image equations is established for each object position. This can be done, for example, by means of an evaluation unit E. The system of equations is then solved for the unknown distances of the features. These distances can also be indicated relative to a basic distance (e.g., relative to the table surface on which the object is shifted). In that case they are referred to as feature heights.

A further exemplary embodiment for calculating the feature distances first generates a model in the center of the image. The object is then shifted in small increments in the direction of the edge of the image. After each shifting step and after the partial recognition with position calculation, the model is adjusted to the new object position, i.e., the new perspective distortion, with respect to its position parameters. After a few of these adjustment steps, a distance from the optical center (or a relative height above the shifting plane) can be calculated for each shape feature through a comparison with the original model. This shifting is done starting from the center of the image in different directions (e.g., to the four corners of the image). Using a compensating calculation across all shifting steps, the distance from the optical center can be determined with great accuracy for each shape feature. This also ensures an automatic determination of the height, i.e., the distance from the camera, of individual shape features. By rotating the object, it is possible to see, and to include in the model, shape features for different perspectives that had been hidden for one position or for a limited position range (e.g., in the image center).

The invention is optimally suited for industrial production systems for automatic optical partial recognition. In this case, the object of the invention is to determine the position or the mounting location of objects, parts or work pieces in the production process and/or to recognize their type or identity. The invention can also be used in quality control to determine completeness, production errors, damage or other quality defects of objects.

The images could in principle be recorded using a camera, suitable robotics and a computer system. The robotics ensures that the objects to be recorded are placed under the camera under different conditions. The camera first records areas of the image in accordance with the instructions of a computer. These areas are first stored and evaluated by a suitable stored computer program using the method according to the invention.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A method for automatically generating an object descriptive model, wherein:
a selection of image signal information is recorded in an object descriptive group having object descriptive shape features, and
similarity criteria yield a decision whether an object descriptive feature is assigned to the group, and
a selectable threshold yields a decision whether the group becomes a part of the recognition model, and
at least strong groups are used for a model for a partial recognition of an object, strength being determined by the number of the group features, and
after a first model has been generated, additional images are recorded, wherein new object descriptive features are obtained by subjecting the new features to a similarity determination, and sufficiently similar new features are added to existing groups in completing the groups.

2. The method as claimed in claim 1, wherein the new object descriptive features are added to the existing groups based on the similarity determination until the groups no longer change significantly.

3. The method as claimed in claim 1, wherein statistical values are used to determine a degree of similarity between the features already included in the groups and the new features.

4. The method as claimed in claim 1, wherein at least one of mean values and maximum values is used to determine a degree of similarity.

5. The method as claimed in claim 1, wherein scattered measured values are stored for each object descriptive feature and are used to characterize a model.

6. The method as claimed in claim 1, wherein a first partial recognition of an object shifted from the optical image recording axis is used to obtain transformation coefficients for a shifted object position, and wherein an inverse transformation is used to add sufficiently similar shape features of the shifted object to respective ones of the existing groups, to produce larger groups.

7. The method as claimed in claim 6, wherein the transformation coefficients describe at least one of a change in size and a change in position of the object.

8. The method as claimed in claim 1, wherein the images are recorded under at least one of more difficult conditions, changed image recording conditions, changed lighting, and a changed object position, and wherein object features are extracted from the images and sufficiently similar shape features of the object are added to respective ones of the existing groups, to produce larger groups.

9. The method as claimed in claim 1, wherein image equations are established from one object position, in accordance with an image recording technique and a perspective distortion, to determine s relative position of an object feature.

10. The method as claimed in claim 1, wherein an object descriptive model is generated from a central position in an object recording field and the model is used for the partial recognition of the object when shifted, to generate a more extensive model for at least one additional object position.

11. The method as claimed in claim 10, wherein the object is shifted in a plurality of directions, and the model is adjusted with each step.

12. The method as claimed in claim 11, wherein a compensating calculation across all shifting steps yields a relative three-dimensional position of at least one of the object and the object feature.
